(19) United States
(12) Patent Application Publication
(10) Pub. No.: US 2003/0225551 A1
(43) Pub. Date: Dec. 4, 2003

(54) Method for remotely monitoring device and installations and a computer unit therefor

(76) Inventors: Jens Hoerner, Hannover (DE); Volker Gies, Hannover (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/204,092

(22) PCT Filed: Feb. 3, 2001
(86) PCT No.: PCT/DE01/00427

(30) Foreign Application Priority Data
Feb. 19, 2000 (DE) 100 07 680.7

(51) Int. Cl. G06F 15/00

(52) U.S. Cl. 702/188

(57) ABSTRACT

The invention relates to a method for remotely controlling devices and installations using a network (1) comprising at least one client-computer unit (3) and at least one server-computer unit (2), whereby measurement data (M) can be transmitted from the server-computer unit(s) (2) to the client-computer unit(s) (3). According to said method, a monitoring routine (10,11) is started on a server-computer unit (2) by a client-computer unit (3). The measurement variables (M) are determined by the client-computer unit (3). The monitoring routine (10, 11) is configured for automatically transmitting the determined measurement data (M) via the network (1) to the corresponding client-computer unit (3) and the measurement data (M) is only transmitted if the modification of the measurement data (M) lies outside a defined fluctuation range (Δ M).

The invention relates to a method for remotely monitoring devices and installations over a network having at least one client computer unit and at least one server computer unit, where measured data can be transferred from the at least one server computer unit to the at least one client computer unit.

The remote monitoring and remote control of devices and installations over a network is sufficiently well known in principle. In this context, monitoring tasks are performed locally by server computer units, such as camera monitoring of objects, process data monitoring in production installations, and remote maintenance of installations. This involves the measured data being continuously recorded by the local server computer unit. A client computer unit can connect itself in a network to the server computer unit and can retrieve the stored measured data as required. Monitoring is effected on the basis of the “pull method”, where the client computer units are respectively responsible for controlling the monitoring.

Systems are also known in which a client computer unit and a server computer unit are connected to one another continuously via a data line, in which case a permanent data link is defined. This rigid data link does not allow a multiplicity of server and client computer units to be networked dynamically.

In addition, the problem arises that the network recording often needs to take place in real time, whereas the network transfer does not have real-time capability. This problem is conventionally solved by virtue of the measured data being buffered-stored in the server computer unit, and breaks in measured value recording being used to empty the buffer. This disadvantageously requires a relatively high level of memory involvement.

It is therefore an object of the invention to provide an improved method for remotely monitoring devices and installations.

The object is achieved by virtue of a monitoring routine on a server computer system being started by a client computer system, with the measured variables to be monitored being stipulated by the client computer unit. The monitoring routine is designed to transfer the stipulated measured data to the corresponding client computer unit over the network automatically. A transfer is made only if the measured data change beyond a defined range of fluctuation.

According to the invention, the real-time recording of measured data is brought into line with the network transfer capacity with no real-time capability by virtue of only changes in the measured data which go beyond a defined range of fluctuation being transferred to the requesting client computer unit, and the data being provided with a time stamp. In contrast to the known methods, it is now proposed that the remote monitoring method be performed on the basis of the push principle. To this end, monitoring routines are started on the server computer unit. These monitoring routines are executed autonomously on the server computer unit and generate transmission transactions to the client computer unit without the need for any control by the client computer unit. The monitoring routines and their data transfer routines can be loaded dynamically onto the server computer unit over the network by authorized client computer units for execution.

The method can advantageously also be used for remotely controlling the devices and installation, by virtue of control data being transferred from a client computer unit to a server computer unit and being converted by the server computer unit. All other client computer units which are logged on immediately receive a message about the new state of the server unit.

It is also advantageous if the parameters for the monitoring routine, particularly the range of fluctuation for the measured data, are stipulated by the corresponding requesting client computer unit when the monitoring routine is started.

The monitoring routines on a server computer unit are advantageously executed more or less in parallel. Provided that the monitoring routines are in the form of object-oriented program classes, they can generate “threads”, for example, which are executed in parallel and store the measured data to be transferred as parameters. The threads autonomously provide for data transfer by calling appropriate program classes.

It is particularly advantageous if the server computer unit sends a confirmation request at defined intervals to the corresponding client computer units for which a monitoring routine on the server unit is executed. This prevents a monitoring routine from continuing to be executed even though the associated client computer unit has already terminated the network connection. Thus, if the corresponding client computer unit does not send any acknowledgement of the confirmation requests to the server computer unit, the corresponding monitoring routine is ended.

To protect the method against unauthorized use, the client computer unit is authenticated by the server computer unit during execution of the protocol for setting up the network connection between the client computer unit and the server computer unit.

In contrast to conventional remote monitoring methods, the security check is thus actually performed before a network connection has been set up. The authentication is thus part of the network connection protocol, e.g. of the protocol for setting up a TCP/IP connection.

Advantageously, the measured data and control data are also transferred in encrypted form.

It is also advantageous to stipulate and check access rights for the client computer units for remote monitoring and/or remote control. Particularly for remote control, contrary control by a plurality of client computer units is thus prevented.

The server computer units advantageously have an operating system core with real-time capability and multitasking capability which involves dynamic loading and execution of the monitoring routines, the security checking routines, the network protocol routines and the bus driving routines for driving a data bus for connecting measured data recording units and control units for the devices and installations.

The method can also be mentioned advantageously with regard to the fact that the measured data are transferred to a database situated in the network. This is advantageously done using platform-dependent program modules, e.g. using JDBC program classes or using services such as e-mail, FTP (File Transfer Protocol) or SMS (Short Message Service).

The measured data are advantageously not buffer-stored. Only the changes in the measured data are buffered by incorporation into the corresponding monitoring routines.

A client computer unit can simultaneously be used as a server computer unit for other client computer units, and vice versa.

The invention is explained in more detail below with reference to the appended drawings, in which:

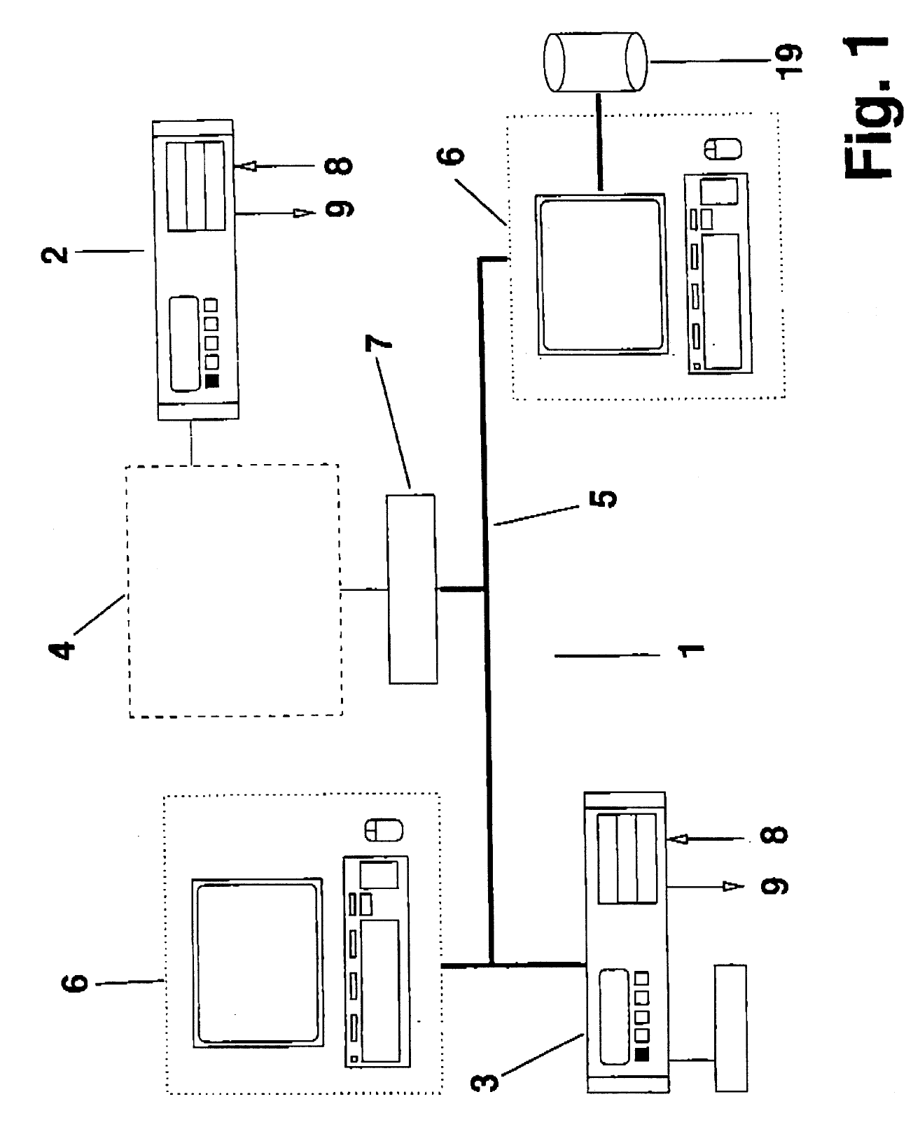

FIG. 1 shows a block diagram of a system for remotely monitoring and remotely controlling devices and installations on the basis of the inventive method;

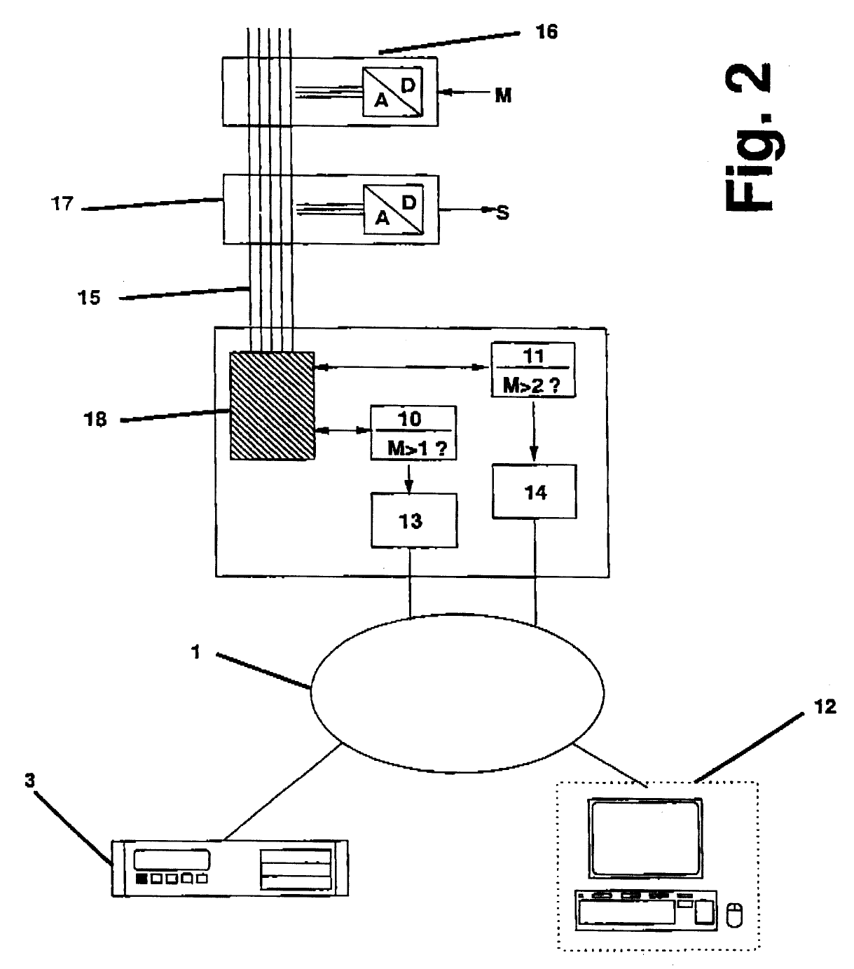

FIG. 2 shows a block diagram of a computer unit for carrying out the method.

FIG. 1 shows a block diagram of a system for remotely monitoring and remotely controlling devices and installations over a network 1 to which at least one server computer unit 2 and a client computer unit 3 are connected. The server computer unit 2 is arranged at a distance from the client computer unit 3 over the Internet 4, for example. The client computer unit 3 is connected to further computers 6, which can be used either as evaluation units or as client/server computer units 3, 2, via an intranet 5. Access to the Internet 4 in the network 1 is protected against unauthorized access by virtue of a “firewall” 7.

The server computer units 2 and the client computer units 3 each have an analog/digital input 8 for recording measured data and an analog/digital output 9 for converting control data into control signals for the devices and installations. External devices can also be connected using various other bus systems (e.g. RS 232, CAN, GPIB).

To perform remote monitoring, a client computer unit 3 starts a monitoring routine on a selected server computer unit 2. This monitoring routine can be in the form of a Java class, for example, i.e. an object-oriented program code in an operating system which has real-time capability and multitasking capability on the server computer unit 2. Such monitoring routines can be started by one and/or more client computer units 3 in parallel and can be executed more or less in parallel on account of the operating system with multitasking capability.

FIG. 2 shows a computer unit, e.g. a server computer unit 2, in which a first monitoring routine 10 sends a change in the measured data M to a first client computer unit 3 as soon as the change Δ M in the measured value is M>1. A second monitoring routine 11 for a second client computer unit 12 observes the measured value M more or less in parallel and, by contrast, sends the current measured value only if the change Δ M in the measured value is >2. These details are given merely by way of example. The monitoring routines 10 and 11 are shown in parallel with one another as “threads”. The measured value data are transferred to the threads as variables and are buffer-stored as such in the server computer unit 2. By contrast, the measured data are not stored separately. The monitoring routines 10 and 11 are designed such that they activate further program classes 13, 14 in order, by way of example, to drive interfaces, such as intranet, GSM, etc., and to control the data transfer to the corresponding client computer unit 3, 12. This considerably reduces the memory involvement. The monitoring routines 10, 11 and their data transfer routines, that is to say the program classes 13, 14, can be loaded dynamically over the network by authorized clients for execution on the server.

FIG. 2 also shows that the server computer unit 2 has a bus 15 to which measured data recording units 16 or control units 17 for the devices and installations are connected. The measured data recording units 16 can, by way of example, contain analog/digital converters which are used to convert the analog measured data M into digital data. Correspondingly, the digital control data can, if appropriate, be converted into analog control signals S by analog/digital converters on the control units 17.

Particularly as a result of the dynamic loading and execution of the monitoring routines 10, 11 in an operating system core 18 in the computer unit 2, 3, the system thus affords a network-integrated measurement, control and regulation system which is independent of operating system. The network connection can be set up, by way of example, on the basis of the standardized, worldwide TCP/IP protocol, which means that the latter can be integrated into the Internet 4 or into an intranet 5. The monitoring routines, the security checking routines, the network protocol routines and the bus driving routines can be programmed as Java applets, for example, so that the client computer units 3 and server computer units 2 can be visualized and controlled independently of operating system. It is then also possible to access the server computer units from any computer 6 with Java capability over the network 1 without further software. The functionalities of the server computer unit 2, particularly starting of the monitoring routines 10 and 11, can be effected dynamically during the system's run time. By virtue of the monitoring routines 10, 11 being event-controlled, for example as a result of measured data being transferred only when a defined range of fluctuation Δ M for the measured data M is exceeded, it is possible to minimize the network loading and to use the method for remote monitoring in real time also, even though the network 1 does not have real-time capability. The security checking routines can be integrated into the network protocol routines, with the client computer unit 3 being authenticated when the protocol for setting up the network connection is executed. The data for the authentication can be made available on a separate database incorporated into the network 1 at any desired point. Authentication can be effected in a plurality of stages, with access rights being able to be stipulated and checked. This can be, by way of example, read and/or read/write authorization for measured data M.

This data transfer can be effected in encrypted form.

If a database application has been installed on a computer 6, as outlined in FIG. 1, the recorded measured data can be written to the database 19 directly over the network 1.

1. A method for remotely monitoring devices and installations over a network (1) having at least one client computer unit (3) and at least one server computer unit (2), where measured data (M) can be transferred from the at least one server computer unit (2) to the at least one client computer unit (3), characterized in that a monitoring routine (10, 11) on a server computer unit (2) is started by a client computer unit (3), with the measured variables to be monitored being stipulated by the client computers (3), the monitoring routine (10, 11) being designed to transfer the stipulated measured data (M) to the corresponding client computer unit (3) over the network (1) automatically, and with the measured data (M) being transferred only if the measured data (M) change beyond a defined range of fluctuation (Δ M).

2. The method as claimed in claim 1, characterized by transfer of control data (S) for remotely controlling the devices and installations from the client computer unit (3) to the server computer unit (2).

3. The method as claimed in claim 1 or 2, characterized in that the range of fluctuation (Δ M) is respectively stipulated by the corresponding client computer unit (3).

4. The method as claimed in one of the preceding claims, characterized in that the monitoring routines (10, 11) started by the at least one client computer unit (3) on a server computer unit (2) are executed more or less in parallel.

5. The method as claimed in one of the preceding claims, characterized in that the server computer unit (2) sends a confirmation request at defined intervals to the corresponding client computer units (3) for which a monitoring routine (10, 11) on the server computer unit (2) is executed, and execution of a monitoring routine (10, 11) is ended if no confirmation signal is returned to the server computer unit (2) by the corresponding client computer unit (3).

6. The method as claimed in one of the preceding claims, characterized by authentication of the client computer unit (3) by the server computer unit (2) during execution of the protocol for setting up the network connection between the client computer unit (3) and the server computer unit (2).

7. The method as claimed in one of the preceding claims, characterized by encrypted transfer of the measured data (M) and control data (S).

8. The method as claimed in one of the preceding claims, characterized by stipulation and checking of access rights for the client computer units (3) for remote monitoring and/or remote control.

9. The method as claimed in one of the preceding claims, characterized by dynamic loading and execution of the monitoring routines (10, 11) in an operating system core (18) in the computer unit (2, 3).

10. The method as claimed in claim 9, characterized by dynamic loading and execution of security checking routines in the operating system core (18).

11. The method as claimed in claim 9 or 10, characterized by execution of network protocol routines in the operating system core (18).

12. The method as claimed in claims 9, 10 or 11, characterized by dynamic loading and execution of bus driving routines in the operating system core (18) for driving a data bus (15) for connecting measured data recording units (16) and control units (17) for the devices and installations.

13. The method as claimed in one of the preceding claims, characterized in that the measured data (M) are buffer-stored merely by incorporation into the monitoring routines (10, 11).

14. The method as claimed in one of the preceding claims, characterized in that a client computer unit (3) can simultaneously also be used as a server computer unit (2), and a server computer unit (2) can simultaneously also be used as a client computer unit (3).

15. A computer unit having a processor, having an operating system core (18) and having a network connection, where the computer unit is designed for carrying out the method as claimed in one of claims 1 to 15.
